(19) United States
(12) Patent Application Publication
(10) Pub. No.: US 2026/0230820 A1
(43) Pub. Date: Aug. 6, 2026

(54) UPPER-LAYER CONTROL INFORMATION PROTECTION AT A MEDIUM ACCESS CONTROL (MAC) LAYER

(71) Applicant: QUALCOMM Incorporated, San Diego, CA (US)

(72) Inventors: Soo Bum LEE, San Diego, CA (US); Linhai HE, San Diego, CA (US); Gavin Bernard HORN, La Jolla, CA (US)

(21) Appl. No.: 19/046,390

(22) Filed: Feb. 5, 2025

(51) Int. Cl. H04W 12/08

(52) U.S. Cl. CPC H04W 12/08

(57) ABSTRACT

An apparatus, method and computer-readable media are disclosed for accessing a wireless network. For example, a process for accessing to a wireless network can include: determining, at a radio link control (RLC) layer, that a RLC protocol data unit (PDU) is to be protected using medium access control (MAC) layer security; transmitting a first RLC PDU with a security indication for MAC layer security to a MAC layer; and applying MAC layer security to a MAC subPDU based on the security indication, wherein the MAC subPDU is generated based on the first RLC PDU.

### FIELD

The present disclosure generally relates to wireless communications. For example, aspects of the present disclosure relate to upper-layer control information protection at a MAC layer of a wireless network.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for securing communications for a wireless network is provided. The apparatus includes a memory and a processor coupled to the memory and configured to: determine, at a radio link control (RLC) layer, that a RLC protocol data unit (PDU) is to be protected using medium access control (MAC) layer security; transmit a first RLC PDU with a security indication for MAC layer security to a MAC layer; and apply MAC layer security to a MAC subPDU based on the security indication, wherein the MAC subPDU is generated based on the first RLC PDU.

As another example, a method for securing communications for a wireless network is provided. The method includes: determining, at a radio link control (RLC) layer, that a RLC protocol data unit (PDU) is to be protected using medium access control (MAC) layer security; transmitting a first RLC PDU with a security indication for MAC layer security to a MAC layer; and applying MAC layer security to a MAC subPDU based on the security indication, wherein the MAC subPDU is generated based on the first RLC PDU.

In another example, a non-transitory computer-readable medium having stored thereon instructions is provided. The instructions, when executed by a processor, causes the processor to: determine, at a radio link control (RLC) layer, that a RLC protocol data unit (PDU) is to be protected using medium access control (MAC) layer security; transmit a first RLC PDU with a security indication for MAC layer security to a MAC layer; and apply MAC layer security to a MAC subPDU based on the security indication, wherein the MAC subPDU is generated based on the first RLC PDU.

As another example, an apparatus for securing communications for a wireless network is provided. The apparatus includes: means for determining, at a radio link control (RLC) layer, that a RLC protocol data unit (PDU) is to be protected using medium access control (MAC) layer security; means for transmitting a first RLC PDU with a security indication for MAC layer security to a MAC layer; and means for applying MAC layer security to a MAC subPDU based on the security indication, wherein the MAC subPDU is generated based on the first RLC PDU.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a block diagram illustrating a protocol stack of data formats that may be included in a MAC PDU, in accordance with aspects of the present disclosure;

FIG. 6 is a block diagram illustrating a protocol stack with data formats that may be included in a MAC PDU optimized for MAC security, in accordance with aspects of the present disclosure;

FIG. 7 is a flow diagram illustrating a process for securing communications for a wireless network, in accordance with aspects of the present disclosure; and

FIG. 8 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3 5G/New Radio (NR) Standard, 6G, etc.) to provide improvements to wireless communications. A device (e.g., a UE, wireless device, mobile device, etc.) can be configured to access a wireless network (e.g., wireless system) to communicate with other devices. As a part of accessing the wireless network, the device may be configured to authenticate with the wireless network. Based on the authentication, the device may establish one or more security contexts to allow for private communications between the device and services of the wireless network. In some wireless networks, a device connecting to the wireless network may establish a security context with a security function of a core network (e.g., non-access stratum (NAS) security). Based on this security context, additional application layer security may be established on top of this security context.

A MAC layer may be a protocol layer of a wireless protocol stack which manages radio resources for communications between wireless nodes and wireless devices in some wireless networks. A wireless protocol stack may be a set of protocols structured in layers which define how wireless devices can communicate with each other. The MAC layer may be hosted by DUs associated with a CU (e.g., centralized wireless node). The centralized wireless node may be a CU, where the CU may be a part of a disaggregated base station which provides support for high layers of a wireless protocol stack. The DU may be another part of the disaggregated base station which provides support for lower layers of the wireless protocol stack, such as the MAC layer. The MAC layer may use MAC messages (e.g., in MAC protocol data units (PDU)) to signal various information between a UE (e.g., wireless device) and DU (e.g., wireless node) to manage radio resources. MAC messages may be messages sent and/or received by the MAC layer. The MAC messages may be divided into multiple MAC subPDUs that carry various portions of MAC messages.

In some cases, some MAC subPDUs may not be protected using MAC security. MAC security may be security measures of the MAC layer. For example, in some wireless networks, MAC security may provide ciphering and/or integrity protection to a MAC control element (CE), but not necessarily to other MAC subPDUs. Ciphering, also known as encryption, may transform plaintext to ciphertext (e.g., encrypted text) to protect the plaintext from being read by an attacker. Integrity protection may be a security feature which may verify received data to ensure that the data was not changed. The MAC CE may carry time sensitive control information. Other MAC subPDUs may encapsulate information from other protocol layers, such a radio link control (RLC) PDUs. The RLC PDUs may be data packets sent by an RLC layer of the wireless protocol stack. The RLC layer may perform packetization of data for transmission, depacketization of received data, error correction, retransmission, and the like. A data packet may be a unit of information that may be sent from a transmitter, such as a first layer, to a receiver, such as a second layer. The RLC PDUs may encapsulate information from other protocols of the wireless protocol stack, such as radio resource control (RRC) data, user plane (UP) data, packet data convergence protocol (PDCP) data, and the like. While some of the protocols that may be encapsulated into MAC subPDUs may be protected by other security protocols, such as control plane (CP) security or UP security, some MAC subPDUs may remain unprotected. For example, RLC PDUs and PDCP control PDUs may not be protected by other security protocols. In some cases, it may be useful to extend MAC security to cover MAC subPDUs that are otherwise unprotected.

Systems, apparatuses, processes (also referred to as methods), and computer-readable media (collectively referred to as “systems and techniques”) are described herein for securing communications for a MAC layer of a wireless network. For example, an RLC layer, at a DU, may determine that an RLC PDU should be protected using MAC layer security. For example, this determination may be made because the RLC PDU is a RLC control PDU. An RLC control PDU may be a type of RLC PDU which carries RLC control information, such as status information for RLC PDUs at an RLC receiver indicating whether information has been received (e.g., ACK) or not received (e.g., NACK). As another example, the RLC layer determine that an RLC PDU should be protected using MAC security based on a received indication from another layer, such as a PDCP layer, indicating that a received PDU from that other layer, such as a PDCP control PDU, should be protected.

In some cases, a first RLC PDU may be generated and transmitted to a MAC layer along with an indication for MAC layer security to be applied to the first RLC PDU. In some cases, the first RLC PDU may be transmitted to the MAC layer separate from another RLC PDU that is unprotected by MAC layer security (e.g., does not include an indication for MAC layer security). In some aspects, multiple RLC PDUs that are to be protected by MAC layer security may be sent together. For example, the RLC layer may determine that a second RLC PDU may be protected using MAC layer security and the RLC layer may transmit the first RLC PDU together with the second RLC PDU to the MAC layer. The first RLC PDU and second RLC PDU may be transmitted separate from other RLC PDUs that are to be unprotected by the MAC layer security.

In some cases, the MAC layer may apply MAC layer security to a MAC subPDU that is generated based on the first RLC PDU (and the second RLC PDU, if applicable). In some cases, the MAC subPDU may be arranged after a MAC CE. The MAC subPDU may be arranged contiguously with the MAC CE. In some cases, multiple MAC security protected MAC subPDUs may be arranged contiguously.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

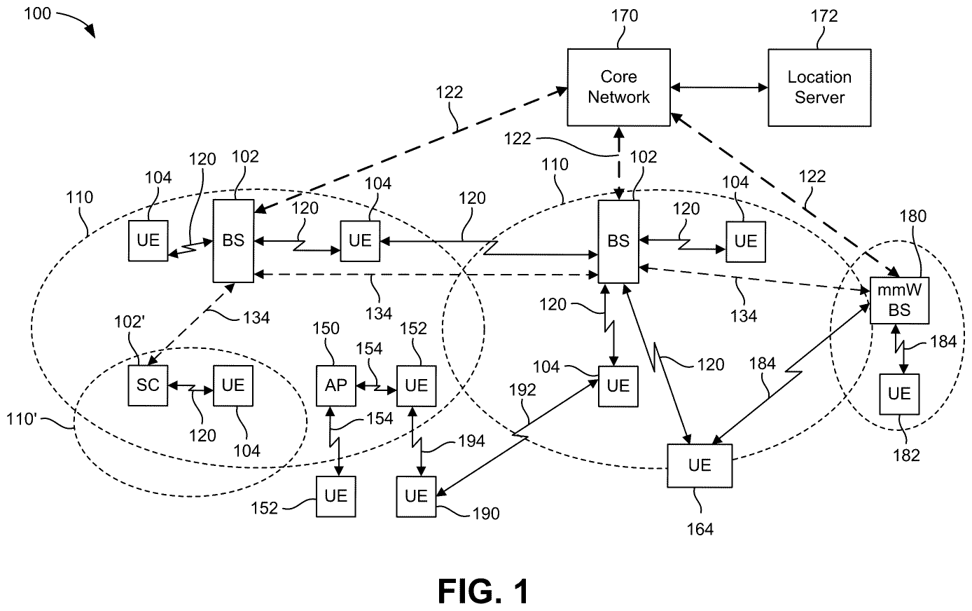

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’without interrupting the service on band ‘X’or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

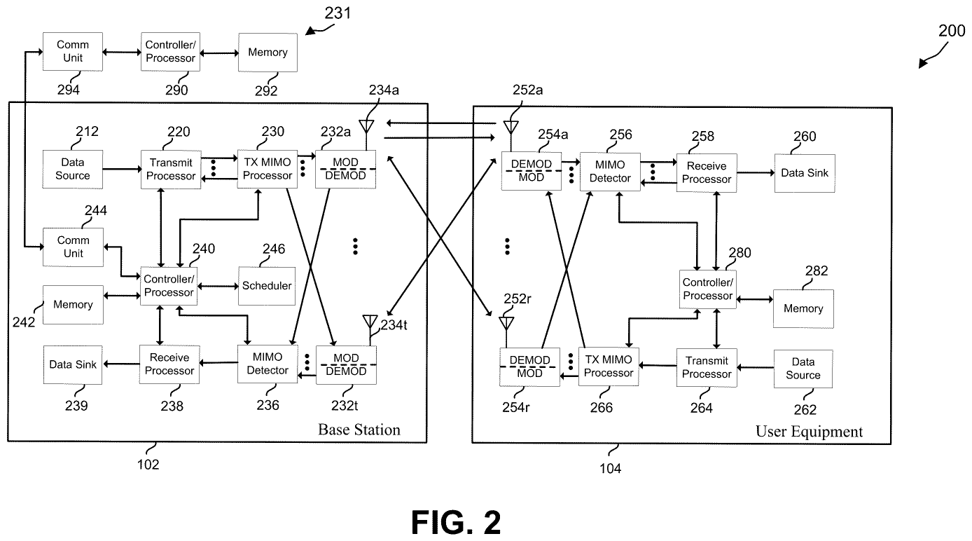

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU (e.g., centralized wireless node) may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

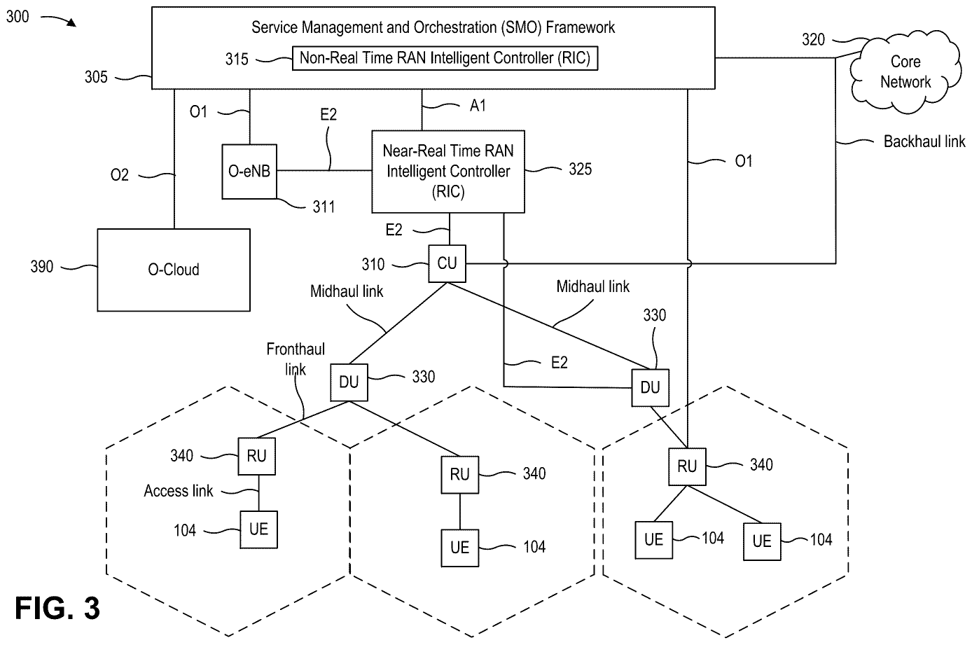

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

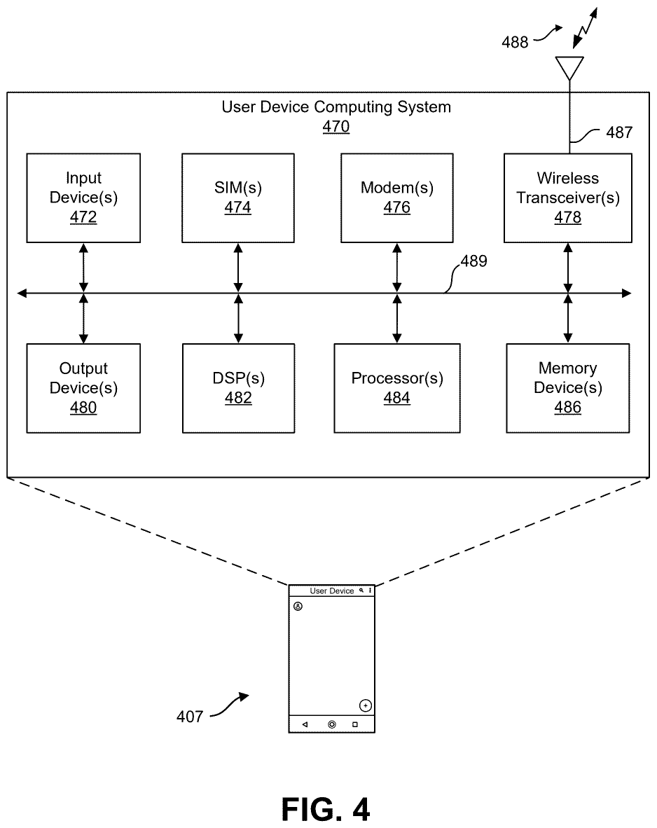

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a BluetoothTM network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

As indicated above, a DU may host a MAC layer. The MAC layer may be a protocol layer which manages radio resources for communications between wireless nodes and wireless devices in some wireless networks. For example, the MAC layer may serve to map between logical channels and transport channels, determine resource allocations, such as time/frequence resources, transmission scheduling, and the like. The MAC layer may also include signaling using MAC protocol data units (PDU) The MAC PDU may be a message format for MAC message (e.g., messages of the MAC layer).

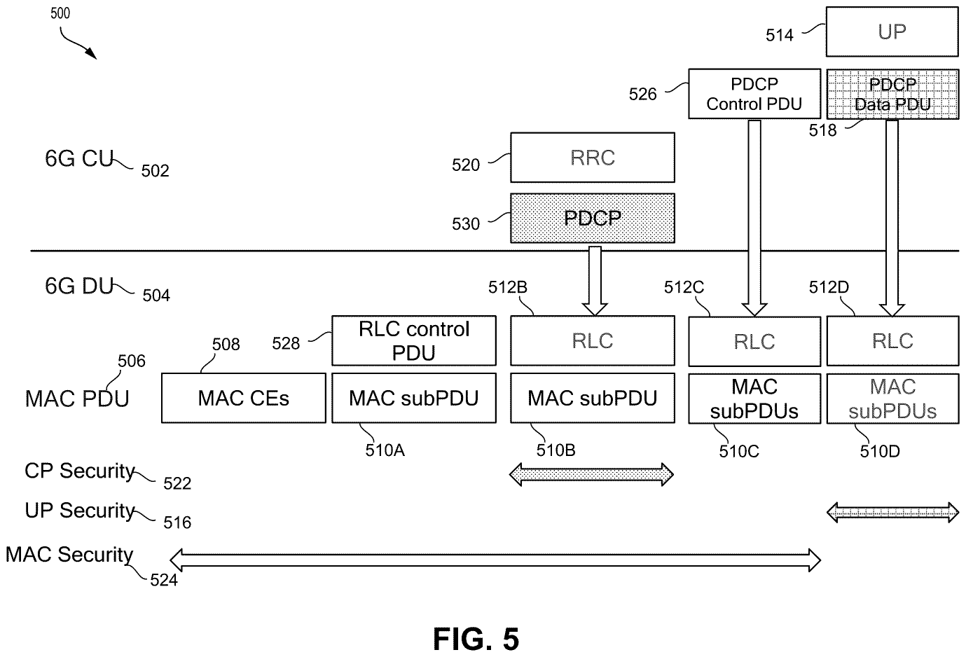

FIG. 5 is a block diagram illustrating a protocol stack 500 of data formats that may be included in a MAC PDU, in accordance with aspects of the present disclosure. FIG. 5 illustrates protocols managed by a CU 502 and DU 504. While discussed in context of wireless nodes (e.g., CU 502/DU 504), it should be understood that the techniques discussed with respect to FIG. 5 may also apply to an aggregated base station (e.g., base station that performs the functions of the CU 502 and DU 504) as well as wireless devices. For example, a wireless device may include an UP, PDCP, RRC, RLC, and MAC protocol layers which may perform the techniques discussed herein in a substantially similar manner. The DU 504 may generate a MAC PDU 506. The MAC PDU 506 may include a MAC CE 508 along with other MAC subPDUs 510A, 510B, 510C, and 510D (collectively, “MAC subPDUs 510”). In some cases, the MAC CE 508 may be a kind of MAC subPDU. In some cases, the MAC subPDUs 510 can carry the MAC CE 508 or radio link control (RLC) PDUs 512B, 512C, and 512D (collectively “RLC PDUs 512”). For example, the CU 502 may obtain user plane (UP) data 514 which may be passed to a packet data convergence protocol (PDCP) layer which provides security and integrity protection. The PDCP layer may apply UP security 516 and generate a PDCP data PDU 518 including the UP data 514. The PDCP data PDU 518 may be transmitted to the DU 504 and packaged into an RLC PDU 512D. The RLC PDU may be packaged into a MAC subPDU 510D. Similarly, the CU 502 may obtain RRC data 520 and the PDCP layer may apply control plane (CP) security 522 to generate a PDCP PDU 530. The PDCP PDU 530 may be transmitted to the DU 504 and packaged in an RLC PDU 512B. The RLC PDU 512B may be packaged into a MAC subPDU 510B. In some cases, the MAC PDU 506 may be a concatenation of the MAC CEs 508 and MAC subPDUs 510. In some cases, as the UP data 514 is protected by UP security 516 and the RRC data 520 is protected by CP security 522, MAC security 524 may not be applied to those corresponding MAC subPDUs 510B and 510D carrying the UP data 514 and RRC data 520.

In some cases, certain PDUs may not be security protected by the PDCP layer. For example, PDCP control PDUs 526 and RLC control PDUs 528 may not be security protected by the PDCP layer. In some cases, the RLC control PDU 528 may carry RLC control information, such as status information for RLC PDUs at an RLC receiver indicating whether information has been received (e.g., ACK) or not received (e.g., NACK). The PDCP control PDU 526 may include PDCP status PDU, header compression information, etc. In some cases, it may be useful to protect the PDCP control PDUs 526 and RLC control PDUs 528 at the MAC layer using MAC security 524.

In some cases, the MAC CEs 508 may be protected using MAC security 524. The MAC security 524 may provide security (e.g., ciphering) and/or integrity protection for the MAC CE 508. As the MAC CEs 508 may be considered a type of MAC subPDU 510, the MAC security 524 used to protect the MAC CEs 508 may be extended to MAC subPDUs 510, including those MAC subPDUs 510 carrying the RLC control PDU 528 and PDCP control PDU 526 (e.g., MAC subPDU 510A and MAC subPDU 510C).

In some cases, simply extending the MAC security 524 from the MAC CEs 508 to include those MAC subPDUs 510 carrying the RLC control PDU 528 and PDCP control PDU 526 may be difficult. For example, RLC control PDU 528 and/or PDCP control PDU 526 may be multiplexed with data PDUs at the RLC layer, such as the RLC PDU 512B and/or RLC PDU 512D. In such cases, the MAC security 524 may not be able to protect the RLC control PDU without also covering the data PDUs, which may redundantly double protect the data PDUs. For example, the RRC data 520 may already be protected by the CP security 522 and the UP data 514 may already be protected by UP security 516.

To avoid double protection, the RLC layer may refrain from concatenating the RLC control PDUs 528 with data PDUs and the RLC layer may separately send (e.g., independently send, send independent of) the RLC control PDUs 528 to the MAC layer for encapsulation into the MAC subPDU 510A. For example, the RLC layer may generate the RLC control PDUs 528 and determine that the PDU is to be secured as the PDU is a control PDU. The RLC layer may then send the RLC control PDUs 528 to the MAC layer. In some cases, the RLC layer may also provide an indication (e.g., flag, set bit, parameter, indication of a type of RLC PDU, etc.) to the MAC layer that the RLC control PDUs 528 should be protected by the MAC layer. In some cases, the indication may also indicate a type of protection that should be provided by the MAC layer (e.g., ciphering and/or integrity protection).

In response to the indication, the MAC layer may construct the MAC subPDU 510A and protect the MAC subPDU 510A along with the MAC CEs 508. In some cases, to organize security protected MAC subPDUs and unprotected (e.g., by MAC security 524) the MAC subPDU 510A may be placed after and adjacent to the MAC CEs 508 in the MAC PDU 506 such that the protected MAC subPDUs are contiguous. For example, a protected RLC PDU should have a higher priority than data, but a lower priority as compared to a MAC CE 508 during logical channel (LCH) prioritization and thus should be included in the MAC PDU 506 after the MAC CE 508. In some cases, the RLC control PDU 528 may be joined (e.g., multiplexed, appended with, concatenated with, etc.) with other MAC subPDUs (e.g., MAC subPDU 510C) that are also protected (e.g., so long as all of the MAC subPDUs are within a set of protected MAC subPDUs in the MAC PDU 506). In some cases, uplink (UL) MAC PDUs may be similarly organized except that an order within the protected MAC subPDUs may be reversed (e.g., MAC CE after the other protected mac subPDUS).

In some cases, the techniques for protecting the RLC control PDU 528 using MAC security 524 may be extended to other layers which may be encapsulated by the RLC layer into the MAC PDU 506. For example, the PDCP control PDU 526 may be bound to a PDCP entity, such as a specific data bearer, such as a data radio bearer (DRB). In some cases, the PDCP control PDU 526 may not be protected by the PDCP layer as doing so may involve adding a new bearer identifier. For example, if the PDCP control PDU is multiplexed with a data PDU protected by PDCP, then processing the multiplexed PDU at a receiver may be complex as there may not be continuity for PDCP sequence numbers as between the data PDU and the PDCP control PDU.

The PDCP control PDU 526 may be passed to the RLC layer and may be combined with (e.g., concatenated with, multiplexed with, etc.) other PDCP data PDUs, such as PDCP data PDU 518, at the RLC layer. If the PDCP control PDU 526 is combined with data PDUs, which may be protected by UP security 516, the data PDUs may be redundantly double protected.

To avoid potential double protection, the PDCP control PDU 526 (or other unprotected PDCP PDU) may be passed to the RLC layer separately (e.g., separate from the PDCP data PDU 518). The PDCP control PDU 526 may also be sent along with an indication (e.g., flag, set bit, parameter, indication of a type of PDCP PDU, etc.) to the RLC layer that the PDU should be protected. The RLC layer may determine to protect the PDCP control PDU 526 based on the indication to the RLC layer to protect the PDU.

The RLC layer may generate the RLC PDU 512C containing the PDCP control PDU 526. The RLC layer may send the generated RLC PDU 512C to the MAC layer with an indication (e.g., flag, set bit, parameter, indication of a type of RLC PDU, etc.) to the MAC layer that the RLC PDU 512B should be protected by the MAC layer. In some cases, the indication may also indicate a type of protection that should be provided by the MAC layer (e.g., security and/or integrity protection). Multiple PDCP PDUs with the indication (e.g., security/integrity protection indication) may be sent to the MAC layer. In response to the indication, the MAC layer may construct the MAC subPDU 510C and protect the MAC subPDU 510C. In some cases, where multiple RLC PDUs are to be protected, multiple PDCP PDUs with the security/integrity protection indication may be sent together to the RLC layer and/or the MAC layer. For example, multiple PDCP PDUs to be security/integrity protected may be sent together to the RLC layer, and multiple RLC PDUs to be MAC protected may be sent together to the MAC layer. The RLC layer may refrain from concatenating RLC PDUs containing PDCP PDUs which are to be protected (e.g., based on the indication from the PDCP layer and sent to the RLC layer) with other RLC data PDUs.

In some cases, MAC subPDUs with RLC PDUs having the security/integrity protection indication may be placed after and adjacent to the MAC CEs 508 in the MAC PDU 506 such that the protected MAC subPDUs are contiguous. However, a MAC security 524 protected MAC subPDU 510C may be multiplexed (e.g., concatenated) with other MAC subPDUs in any order, such as with MAC security 524 protected MAC CE 508 and MAC subPDU 510A, an unprotected (e.g., by MAC security 524) MAC subPDU 510B, and a protected MAC subPDU 510C. In such cases, the MAC PDU 506 may include an indication of specific portions of the MAC PDU 506 are protected and/or an indication of specific portions of the MAC PDU 506 that are unprotected.

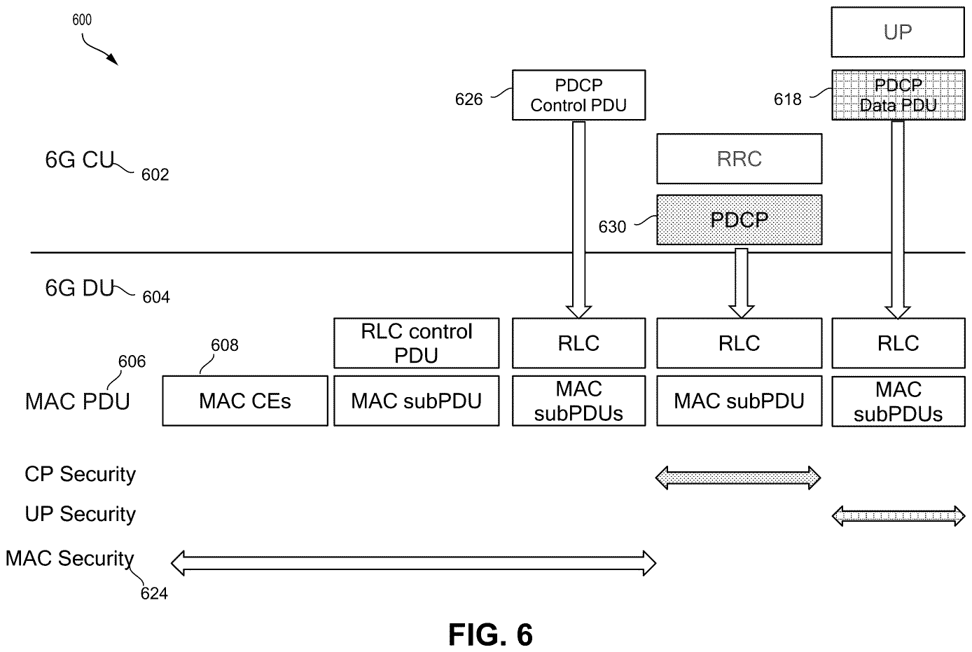

FIG. 6 is a block diagram illustrating a protocol stack 600 with data formats that may be included in a MAC PDU optimized for MAC security, in accordance with aspects of the present disclosure. FIG. 6 is a reorganized view of FIG. 5 and numbered elements in FIG. 6 may be substantially similar to like numbered elements in FIG. 5 (e.g., CU 602 may be substantially similar to CU 502 of FIG. 5, DU 604 may be substantially similar to DU 504 of FIG. 5, MAC PDU 606 may be substantially similar to MAC PDU 506 of FIG. 5, MAC CEs 608 may be substantially similar to MAC CEs 508 of FIG. 5, PDCP data PDU 618 may be substantially similar to PDCP data PDU 518 of FIG. 5, PDCP control PDU 626 may be substantially similar to PDCP control PDU 526 of FIG. 5, MAC security 624 may be substantially similar to MAC security 524 of FIG. 5, PDCP PDU 630 may be substantially similar to PDCP PDU 530 of FIG. 5, etc.). As indicated above, MAC subPDUs with RLC PDUs having the security/integrity protection indication may be placed after and adjacent to the MAC CEs 608 in the MAC PDU 606 such that the protected MAC subPDUs are contiguous. While discussed in context of wireless nodes (e.g., CU 602/DU 604), it should be understood that the techniques discussed with respect to FIG. 6 may also apply to an aggregated base station (e.g., base station that performs the functions of the CU 602 and DU 604) as well as wireless devices. For example, a wireless device may include an UP, PDCP, RRC, RLC, and MAC protocol layers which may perform the techniques discussed herein in a substantially similar manner.

In some cases, PDCP PDUs (e.g., PDCP control PDU 626, PDCP PDU 630, PDCP data PDU 618) from the CU 602 may be received in any order by the RLC layer of the DU 604 and the RLC layer may encapsulate the PDCP PDUs into RLC PDUs (with and without the security/integrity protection indication) and pass the RLC PDUs into the MAC layer in any order. The MAC layer may encapsulate the RLC PDUs into MAC subPDUs and organize the MAC subPDUs such that MAC subPDUs protected by MAC security 624 are arranged contiguously. Arranging the MAC subPDUs protected by MAC security 624 contiguously allows the MAC PDU 606 to be simplified as the MAC PDU can indicate a single range of the MAC PDU 606 as being protected by MAC security 624.

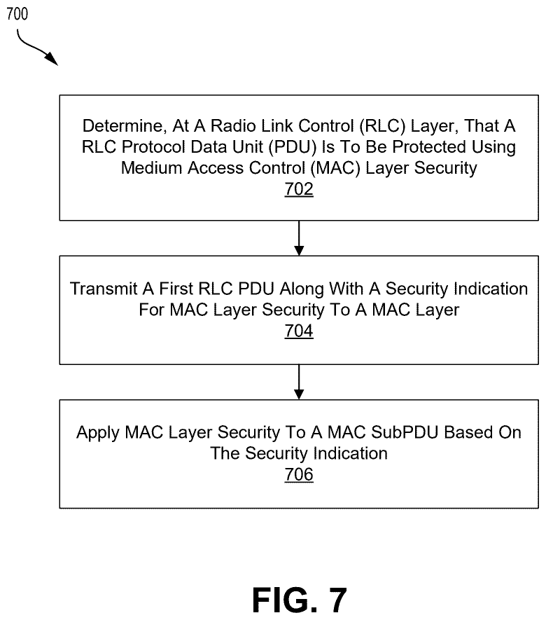

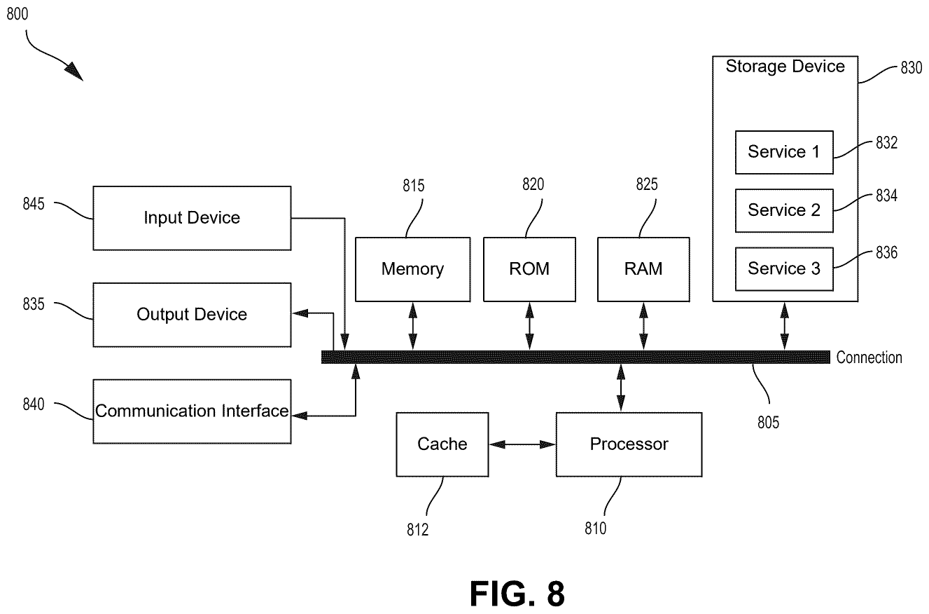

FIG. 7 is a flow diagram illustrating a process 700 for securing communications with a wireless network, in accordance with aspects of the present disclosure. The process 700 can be performed by a component or system (e.g., a chipset, server, device, etc.) of a wireless network (e.g., BS 102, mmW BS 180, core network 170 of FIG. 1, core network 320 of FIG. 3, SMO Framework 305 of FIG. 3, O-eNB 311 of FIG. 3, RIC 325 of FIG. 3, O-Cloud 390 of FIG. 3, CU 310 of FIG. 3, DU 330 of FIG. 3, CU 502 of FIG. 5, DUs 504 of FIG. 5, CU 602 of FIG. 6, DUs 604 of FIG. 6, computing system 800 of FIG. 8, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device (e.g., UE 104, of FIGS. 1 and 2, respectively, wireless device 407 of FIG. 4, computing system 800 of FIG. 8, etc.). The operations of the process 700 may be implemented as software components that are executed and run on one or more processors (e.g., processor 810 of FIG. 8 or other processor(s)). Further, the transmission and reception of signals by the wireless network (or component of the wireless network, such as the security service) in the process 700 may be enabled, for example, by one or more antennas (e.g., antennas 234 of FIG.) and/or one or more transceivers (e.g., modulators/demodulators 232, TX MIMO processor 230, MIMO detector 236, transmit processor 220, receive processor 238 of FIG. 2, etc.).

At block 702, the computing device (or component thereof) may determine, at a radio link control (RLC) layer, that a RLC protocol data unit (PDU) (e.g., RLC control PDUs 528) is to be protected using medium access control (MAC) layer security (e.g., MAC security 524). For example, the RLC layer may generate a control PDU and determine that the PDU is to be secured as the PDU is a control PDU. The RLC layer may then send the RLC control PDU to the MAC layer. As another example, the RLC layer may determine to protect a received PDCP control PDU based on the indication from the PDCP layer to the RLC layer to protect the PDU and the RLC layer may encapsulate the received PDCP control PDU in an RLC PDU. In some examples, the determination that the RLC PDU is to be protected is based on the RLC PDU being a RLC control PDU. In some cases, the computing device (or component thereof) may receive a packet data convergence protocol (PDCP) PDU with an indication that the PDCP PDU is to be protected; and determine that the RLC PDU is to be protected based on the indication that the PDCP PDU is to be protected, wherein the first RLC PDU encapsulates the PDCP PDU. In some cases, the PDCP PDU comprises a PDCP control PDU. In some cases, the PDCP PDU is received from a centralized wireless node, and the computing device may be a wireless node. For example, a CU may include the PDCP layer which generates the PDCP PDU. The RLC layer and MAC layer may be included in the DU, and functionality of the RLC layer and MAC layer may be performed by the DU.

At block 704, the computing device (or component thereof) may transmit a first RLC PDU (e.g., RLC control PDUs 528 and/or RLC PDUs 512C of FIG. 5, etc.) with a security indication for MAC layer security to a MAC layer. For example, the RLC layer may provide an indication (e.g., flag, set bit, parameter, indication of a type of RLC PDU, etc.) to the MAC layer that an RLC PDU, such as RLC control PDUs 528 of FIG. 5, should be protected by the MAC. In some cases, the first RLC PDU is transmitted to the MAC layer separately from at least one other RLC PDU. For example, to avoid double protection, the RLC layer may refrain from concatenating the RLC control PDUs with data PDUs and the RLC layer may separately send the RLC control PDUs to the MAC layer for encapsulation into the MAC subPDU. In some cases, the computing device (or component thereof) may determine that a second RLC PDU is to be protected using MAC layer security and transmit the second RLC PDU and the first RLC PDU to the MAC layer together. In such cases, the first RLC PDU and the second RLC PDU may be transmitted separately from other RLC PDUs. For example, multiple RLC PDUs to be MAC protected may be sent together to the MAC layer. In some examples, the computing device (or component thereof) may transmit the first RLC PDU to the MAC layer independent of other RLC PDUs. In some cases, the computing device (or component thereof) may be a wireless device. For example, the wireless device may include the RDCP layer, RRC layer, RLC layer, and MAC layer and operations of the RDCP layer, RRC layer, RLC layer, and MAC layers may be performed by the wireless device.

At block 706, the computing device (or component thereof) may apply MAC layer security to a MAC subPDU (e.g., MAC subPDUs 510A, 510C of FIG. 5, etc.) based on the security indication, wherein the MAC subPDU is generated based on the first RLC PDU. In some cases, the MAC subPDU is arranged after a MAC control element (CE) (e.g., MAC CEs 508 of FIG. 5) in a MAC PDU. In some examples, the MAC CE and the MAC subPDU are arranged contiguously. For example, MAC subPDUs with RLC PDUs having the security/integrity protection indication may be placed after and adjacent to the MAC CEs in the MAC PDU such that the protected MAC subPDUs are contiguous. In some cases, the computing device (or component thereof) may transmit a second RLC PDU (e.g., RLC PDU 512B, 512D of FIG. 5) without the security indication for MAC layer security to the MAC layer, wherein a second MAC subPDU (e.g., MAC subPDU 510B, 510D of FIG. 5) generated based on the second RLC PDU is unprotected by MAC layer security.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 900 and/or other processes described herein may include a processor, microprocessor, micro-computer, or other component of a device that is configured to carry out the steps of the process 900 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 900 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 900 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some embodiments, computing system 800 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some embodiments, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for securing communications for a wireless network, comprising: a memory; and a processor coupled to the memory and configured to: determine, at a radio link control (RLC) layer, that a RLC protocol data unit (PDU) is to be protected using medium access control (MAC) layer security; transmit a first RLC PDU with a security indication for MAC layer security to a MAC layer; and apply MAC layer security to a MAC subPDU based on the security indication, wherein the MAC subPDU is generated based on the first RLC PDU.
Aspect 2. The apparatus of Aspect 1, wherein the first RLC PDU is transmitted to the MAC layer separately from at least one other RLC PDU.
Aspect 3. The apparatus of any of Aspects 1-2, wherein the processor is further configured to: determine that a second RLC PDU is to be protected using MAC layer security; and transmit the second RLC PDU and the first RLC PDU to the MAC layer together, wherein the first RLC PDU and the second RLC PDU are transmitted separately from other RLC PDUs.
Aspect 4. The apparatus of any of Aspects 1-3, wherein the determination that the RLC PDU is to be protected is based on the RLC PDU being a RLC control PDU.
Aspect 5. The apparatus of any of Aspects 1-4, wherein the MAC subPDU is arranged after a MAC control element (CE) in a MAC PDU.
Aspect 6. The apparatus of Aspect 5, wherein the MAC CE and the MAC subPDU are arranged contiguously.
Aspect 7. The apparatus of any of Aspects 1-6, wherein the processor is further configured to transmit a second RLC PDU without the security indication for MAC layer security to the MAC layer, wherein a second MAC subPDU generated based on the second RLC PDU is unprotected by MAC layer security.
Aspect 8. The apparatus of any of Aspects 1-7, wherein the processor is further configured to: receive a packet data convergence protocol (PDCP) PDU with an indication that the PDCP PDU is to be protected; and determine that the RLC PDU is to be protected based on the indication that the PDCP PDU is to be protected, wherein the first RLC PDU encapsulates the PDCP PDU.
Aspect 9. The apparatus of Aspect 8, wherein the processor is further configured to transmit the first RLC PDU to the MAC layer independent of other RLC PDUs.
Aspect 10. The apparatus of Aspect 8, wherein the PDCP PDU comprises a PDCP control PDU.
Aspect 11. The apparatus of any of Aspects 8-10, wherein the PDCP PDU is received from a centralized wireless node, and wherein the apparatus comprises a wireless node.
Aspect 12. The apparatus of any of Aspects 1-10, wherein the apparatus comprises a wireless device.
Aspect 13. A method for securing communications for a wireless network, comprising: determining, at a radio link control (RLC) layer, that a RLC protocol data unit (PDU) is to be protected using medium access control (MAC) layer security; transmitting a first RLC PDU with a security indication for MAC layer security to a MAC layer; and applying MAC layer security to a MAC subPDU based on the security indication, wherein the MAC subPDU is generated based on the first RLC PDU.
Aspect 14. The method of Aspect 13, wherein the first RLC PDU is transmitted to the MAC layer separately from at least one other RLC PDU.
Aspect 15. The method of any of Aspects 13-14, further comprising: determining that a second RLC PDU is to be protected using MAC layer security; and transmitting the second RLC PDU and the first RLC PDU to the MAC layer together, wherein the first RLC PDU and the second RLC PDU are transmitted separately from other RLC PDUs.
Aspect 16. The method of any of Aspects 13-15, wherein the determination that the RLC PDU is to be protected is based on the RLC PDU being a RLC control PDU.
Aspect 17. The method of any of Aspects 13-16, wherein the MAC subPDU is arranged after a MAC control element (CE) in a MAC PDU.
Aspect 18. The method of Aspect 17, wherein the MAC CE and the MAC subPDU are arranged contiguously.
Aspect 19. The method of any of Aspects 13-18, further comprising transmitting a second RLC PDU without the security indication for MAC layer security to the MAC layer, wherein a second MAC subPDU generated based on the second RLC PDU is unprotected by MAC layer security.
Aspect 20. The method of any of Aspects 13-19, further comprising: receiving a packet data convergence protocol (PDCP) PDU with an indication that the PDCP PDU is to be protected; and determining that the RLC PDU is to be protected based on the indication that the PDCP PDU is to be protected, wherein the first RLC PDU encapsulates the PDCP PDU.
Aspect 21. The method of Aspect 20, further comprising transmitting the first RLC PDU to the MAC layer independent of other RLC PDUs.
Aspect 22. The method of any of Aspects 20-21, wherein the PDCP PDU comprises a PDCP control PDU.
Aspect 23. The method of any of Aspects 20-22, wherein the PDCP PDU is received from a centralized wireless node and wherein the method is performed by a wireless node.
Aspect 24. The method of any of Aspects 20-22, wherein the method is performed by a wireless device.
Aspect 25. A non-transitory computer-readable medium having stored thereon instructions that, when executed by a processor, cause the processor to: determine, at a radio link control (RLC) layer, that a RLC protocol data unit (PDU) is to be protected using medium access control (MAC) layer security; transmit a first RLC PDU with a security indication for MAC layer security to a MAC layer; and apply MAC layer security to a MAC subPDU based on the security indication, wherein the MAC subPDU is generated based on the first RLC PDU.
Aspect 26. The non-transitory computer-readable medium of Aspect 25, wherein the first RLC PDU is transmitted to the MAC layer separately from at least one other RLC PDU.
Aspect 27. The non-transitory computer-readable medium of Aspect 25, wherein the instructions further cause the processor to: determine that a second RLC PDU is to be protected using MAC layer security; and transmit the second RLC PDU and the first RLC PDU to the MAC layer together, wherein the first RLC PDU and the second RLC PDU are transmitted separately from other RLC PDUs.
Aspect 28. The non-transitory computer-readable medium of Aspect 25, wherein the determination that the RLC PDU is to be protected is based on the RLC PDU being a RLC control PDU.
Aspect 29. The non-transitory computer-readable medium of Aspect 25, wherein the MAC subPDU is arranged after a MAC control element (CE) in a MAC PDU.
Aspect 30. The non-transitory computer-readable medium of Aspect 29, wherein the MAC CE and the MAC subPDU are arranged contiguously.
Aspect 31. The non-transitory computer-readable medium of Aspect 25, wherein the instructions further cause the processor to transmit a second RLC PDU without the security indication for MAC layer security to the MAC layer, wherein a second MAC subPDU generated based on the second RLC PDU is unprotected by MAC layer security.
Aspect 32. A non-transitory computer-readable medium having stored thereon instructions that, when executed by at least one processor, cause the at least one processor to perform operations according to any of Aspects 13-24.
Aspect 33. An apparatus for securing communications for a wireless network comprising one or more means for performing operations according to any of Aspects 13-24.

What is claimed is:

1. An apparatus for securing communications for a wireless network, comprising:
a memory; and
a processor coupled to the memory and configured to:
determine, at a radio link control (RLC) layer, that a RLC protocol data unit (PDU) is to be protected using medium access control (MAC) layer security;
transmit a first RLC PDU with a security indication for MAC layer security to a MAC layer; and
apply MAC layer security to a MAC subPDU based on the security indication, wherein the MAC subPDU is generated based on the first RLC PDU.

2. The apparatus of claim 1, wherein the first RLC PDU is transmitted to the MAC layer separately from at least one other RLC PDU.

3. The apparatus of claim 1, wherein the processor is further configured to:
determine that a second RLC PDU is to be protected using MAC layer security; and
transmit the second RLC PDU and the first RLC PDU to the MAC layer together, wherein the first RLC PDU and the second RLC PDU are transmitted separately from other RLC PDUs.

4. The apparatus of claim 1, wherein the determination that the RLC PDU is to be protected is based on the RLC PDU being a RLC control PDU.

5. The apparatus of claim 1, wherein the MAC subPDU is arranged after a MAC control element (CE) in a MAC PDU.

6. The apparatus of claim 5, wherein the MAC CE and the MAC subPDU are arranged contiguously.

7. The apparatus of claim 1, wherein the processor is further configured to transmit a second RLC PDU without the security indication for MAC layer security to the MAC layer, wherein a second MAC subPDU generated based on the second RLC PDU is unprotected by MAC layer security.

8. The apparatus of claim 1, wherein the processor is further configured to:
receive a packet data convergence protocol (PDCP) PDU with an indication that the PDCP PDU is to be protected; and
determine that the RLC PDU is to be protected based on the indication that the PDCP PDU is to be protected, wherein the first RLC PDU encapsulates the PDCP PDU.

9. The apparatus of claim 8, wherein the processor is further configured to transmit the first RLC PDU to the MAC layer independent of other RLC PDUs.

10. The apparatus of claim 8, wherein the PDCP PDU comprises a PDCP control PDU.

11. The apparatus of claim 8, wherein the PDCP PDU is received from a centralized wireless node, and wherein the apparatus comprises a wireless node.

12. The apparatus of claim 1, wherein the apparatus comprises a wireless device.

13. A method for securing communications for a wireless network, comprising:
determining, at a radio link control (RLC) layer, that a RLC protocol data unit (PDU) is to be protected using medium access control (MAC) layer security;
transmitting a first RLC PDU with a security indication for MAC layer security to a MAC layer; and
applying MAC layer security to a MAC subPDU based on the security indication, wherein the MAC subPDU is based on the first RLC PDU.

14. The method of claim 13, wherein the first RLC PDU is transmitted to the MAC layer separately from at least one other RLC PDU.

15. The method of claim 13, further comprising:
determining that a second RLC PDU is to be protected using MAC layer security; and
transmitting the second RLC PDU and the first RLC PDU to the MAC layer together, wherein the first RLC PDU and the second RLC PDU are transmitted separately from other RLC PDUs.

16. The method of claim 13, wherein the determination that the RLC PDU is to be protected is based on the RLC PDU being a RLC control PDU.

17. The method of claim 13, wherein the MAC subPDU is arranged after a MAC control element (CE) in a MAC PDU.

18. The method of claim 17, wherein the MAC CE and the MAC subPDU are arranged contiguously.

19. The method of claim 13, further comprising transmitting a second RLC PDU without the security indication for MAC layer security to the MAC layer, wherein a second MAC subPDU generated based on the second RLC PDU is unprotected by MAC layer security.

20. The method of claim 13, further comprising:
receiving a packet data convergence protocol (PDCP) PDU with an indication that the PDCP PDU is to be protected; and
determining that the RLC PDU is to be protected based on the indication that the PDCP PDU is to be protected, wherein the first RLC PDU encapsulates the PDCP PDU.

21. The method of claim 20, further comprising transmitting the first RLC PDU to the MAC layer independent of other RLC PDUs.

22. The method of claim 20, wherein the PDCP PDU comprises a PDCP control PDU.

23. The method of claim 20, wherein the PDCP PDU is received from a centralized wireless node and wherein the method is performed by a wireless node.

24. The method of claim 20, wherein the method is performed by a wireless device.

25. A non-transitory computer-readable medium having stored thereon instructions that, when executed by at least one processor, cause the at least one processor to:
determine, at a radio link control (RLC) layer, that a RLC protocol data unit (PDU) is to be protected using medium access control (MAC) layer security;
transmit a first RLC PDU with a security indication for MAC layer security to a MAC layer; and
apply MAC layer security to a MAC subPDU based on the security indication, wherein the MAC subPDU is generated based on the first RLC PDU.

26. The non-transitory computer-readable medium of claim 25, wherein the first RLC PDU is transmitted to the MAC layer separately from at least one other RLC PDU.

27. The non-transitory computer-readable medium of claim 25, wherein the instructions further cause the processor to:
determine that a second RLC PDU is to be protected using MAC layer security; and
transmit the second RLC PDU and the first RLC PDU to the MAC layer together, wherein the first RLC PDU and the second RLC PDU are transmitted separately from other RLC PDUs.

28. The non-transitory computer-readable medium of claim 25, wherein the determination that the RLC PDU is to be protected is based on the RLC PDU being a RLC control PDU.

29. The non-transitory computer-readable medium of claim 25, wherein the MAC subPDU is arranged after a MAC control element (CE) in a MAC PDU.

30. The non-transitory computer-readable medium of claim 29, wherein the MAC CE and the MAC subPDU are arranged contiguously.
